(19) United States
(12) Patent Application Publication
(10) Pub. No.: US 2013/0008037 A1
(43) Pub. Date: Jan. 10, 2013

(54) T-SQUARE WITH DRYWALL ENGAGEMENT MEMBERS AND CUTTING GUIDE

(76) Inventors: Emmett J. Ebner, Santa Ana, CA (US); Brian J. Huffer, Santa Ana, CA (US)

(21) Appl. No.: 13/176,995

(22) Filed: Jul. 6, 2011

(51) Int. Cl. B43L 7/02

(52) U.S. Cl. 33/42

(57) ABSTRACT

Provided is a T-square including a plurality of gripping elements configured to allow the T-square to engage with a sheet of drywall to maintain the T-square at a desired location on the drywall independent of assistance from a user. The T-square additionally includes a cutting channel formed therein to guide the utility knife to ensure that the user makes a generally linear cut or score line along the drywall. The gripping elements and the cutting channel create a generally safer and more user friendly T-square compared to conventional t-squares because the T-square may be held in place by itself and the cutting channel guides the utility knife as the user cuts the drywall.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

1. Field of the Invention

The present invention relates generally to a T-square, and more specifically to a T-square configured to grip a sheet of drywall, wherein the T-square is additionally configured to include a cutting channel to facilitate cutting of the drywall.

2. Description of the Related Art

Drywall is well known in the construction industry as a common building material generally used to construct interior walls and other generally planar surfaces. Drywall is typically formed by a layer of gypsum plaster pressed between two sheets of paper, with the composite being kiln dried.

Drywall is generally manufactured in standard sizes and then cut to customize the drywall sheet as needed. Those skilled in the art will readily appreciate that T-squares and utility knives are commonly used to cut the drywall to conform the size and shape of the drywall to fit the particular specifications of the construction project. A conventional T-square includes a generally rectangular head element and a generally rectangular tongue element extending perpendicularly from the head element. The head and tongue elements usually include markings which allow a user to use the T-square to measure the drywall. To cut the drywall, the T-square is typically placed along a top edge of the drywall sheet to measure the drywall to determine the location of the desired cut. The utility knife is then run along the side of the T-square tongue to score an outer paper layer of the drywall sheet. The user then “snaps” the drywall to break the drywall along the score line, and then cuts the other paper layer with the utility knife to completely cut the drywall sheet.

Although this conventional method is effective in cutting drywall sheets, there are certain drawbacks associated therewith. One particular drawback is that the use of conventional T-squares to perform the above-described process can be relatively laborious, particularly when repeated routinely on a large construction project. Along these lines, the user is typically required to use one hand to hold the T-square in place relative to the sheet of drywall, while the user's other hand grips the utility knife and cuts the drywall. Therefore, the user may lose focus on the utility knife blade and make unwanted cuts or score in the drywall.

Another drawback commonly associated with the conventional technique described above is a safety concerns for those operating the utility knife. More specifically, the laborious nature of using the conventional T-squares, as mentioned above, may result in the user losing control over the blade and cutting himself.

As is apparent from the foregoing, there exists a need in the art for a safer and easier to use T-square. The present invention addresses this particular need, as will be discussed in more detail below.

### BRIEF SUMMARY OF THE INVENTION

According to an aspect of the present invention, there is provided a T-square configured to facilitate the process of cutting drywall. More specifically, the T-square includes a gripping member configured to temporarily engage the T-square to the drywall to maintain the T-square in place on the drywall while the user cuts the drywall. The T-square may additionally include a cutting channel formed within the tongue of the T-square. The cutting channel extends in a generally axial direction along the length of the T-square tongue and is sized to receive the blade of a utility knife to allow the drywall to be cut as the blade passes through the cutting channel.

The T-square of the present invention provides a safer alternative to conventional t-square and conventional drywall cutting techniques. Along these lines, the gripping member allows the T-square to remain in place on the drywall (i.e., hang from the drywall) independent of the user. In other words, the user is not required to hold the T-square on the drywall while the user cuts the drywall, and instead the user may focus his efforts on safely and accurately scoring or cutting the drywall. Moreover, the cutting channel further assists the user by guiding and containing the blade along the axial cutting path to mitigate inadvertent “drifting” or movement of the blade away from the T-square.

According to one embodiment, the T-square comprises a T-square body including an elongate first head member extending longitudinally along a first axis and an elongate second tongue member extending longitudinally along a second axis generally perpendicular to the first axis. The T-square body further includes a cutting channel formed therein, with the cutting channel extending generally along one of the first axis and the second axis. The T-square additionally includes a plurality of gripping elements connected to the t-square body. The gripping elements are configured to be engageable with the drywall to connect the T-square to the drywall.

The gripping elements may be connected to the first head member and may define a generally triangular configuration, wherein the base of the gripping elements are connected to the head member and the gripping elements extend away from the head member and terminate at an apex. The gripping elements may also be integrally formed with the head member. The gripping elements may further extend away from the head member to define a length that is less than the drywall thickness such that when the gripping elements are advanced into the drywall, the gripping elements do not extend completely through the drywall.

The cutting channel may be formed within the tongue member and extend substantially along the length of the tongue member. The cutting channel may be positioned between the lateral edges of the tongue member.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is front, lower perspective view of a T-square having a plurality of engagement members and a cutting channel, the T-square being engaged with a sheet of drywall to independently hang from the drywall;

FIG. 2 is a cross sectional view of a portion of the T-square depicted in FIG. 1;

FIG. 3 is a partial rear, upper perspective view of the T-square; and

FIG. 4 is a front view of the T-square.

Common reference numerals are used throughout the drawings and detailed description to indicate like elements.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings, there is shown an embodiment of a T-square 10 including a plurality of gripping elements 12 configured to allow the T-square 10 to engage with a sheet of drywall 14 to maintain the T-square 10 at a desired location on the drywall 14. The gripping elements 12 enable the T-square 10 to hang on the drywall 14 independent of assistance from a user. As such, the user may focus on operating a utility knife to cut or score the drywall 14, rather than expending effort to hold the T-square 10 in place. The T-square 10 additionally includes a cutting channel 16 formed therein to guide the utility knife to ensure that the user makes a generally linear cut or score line along the drywall 14. The gripping elements 12 and the cutting channel 16 create a generally safer and more user friendly T-square 10 compared to conventional t-squares because the T-square 10 may be held in place by itself and the cutting channel 16 guides the utility knife as the user cuts the drywall 14.

The T-square 10 includes a t-square body comprised of an elongate first head member 18 which generally extends in a longitudinal direction along a first axis 15, and an elongate second tongue member 20 which generally extend in a longitudinal direction along a second axis 17 which is substantially perpendicular to the first axis 15. The head member 18 and tongue member 20 are both generally quadrangular in shape, with the tongue member 20 defining a length along the second axis 17 which is preferably, but not necessarily, longer than the length defined by the head member 18 along the first axis 15. The head member 18 defines a first face 22 and an opposing second face 24 and the tongue member 20 defines a first face 26 and an opposing second face 28. In the embodiment depicted in the Figures, the tongue member 20 is rigidly connected to the head member 18 to maintain the perpendicular alignment between the head member 18 and the tongue member 20. However, those skilled in the art will appreciate that various embodiments of the T-square 10 include a tongue member 20 that is pivotally connected to the head member 18 which would allow the angular position between the tongue member 20 and the head member 18 to be selectively adjusted.

The plurality of gripping elements 12 are connected to the T-square body and are configured to facilitate engagement with the drywall 14. In the embodiment depicted in the Figures, the gripping elements 12 define a generally triangular configuration and protrude from the first face 22 of the head member 18. The triangular gripping elements 12 define a proximal portion connected to the first face 22 of the head member 18 and a distal portion extending away from the head member 18 to define a distal tip. The plurality of gripping elements 12 are positioned adjacent an edge of the head member 18, and are aligned along a common axis to define an array of gripping elements 12. It is contemplated that the gripping elements 12 may be integrally formed with the head member 18, or detachably connected thereto.

The gripping elements 12 are configured to be advanced into the drywall 14 by pressing the T-square 10 against the drywall 14 to temporarily secure the T-square 10 in place along the drywall 14 while the user cuts the drywall 14. As such, the user may not be required to hold the T-square 10 on the drywall 14 while the drywall 14 is being cut. Thus, the overall process of cutting the drywall 14 may be facilitated by use of the T-square 10. Furthermore, the gripping elements 12 allow the user to focus on operating the utility blade, as opposed to simultaneously holding the T-square 10 in place as well as operating the utility blade, as is required when using a convention t-square.

Referring now to FIG. 2, the gripping elements 12 are shown as being advanced into the drywall 14. The gripping elements 12 are advanced into the drywall 14 by placing the T-square 10 adjacent the drywall 14 with the gripping elements 12 facing the drywall 14 while the T-square 10 is pushed toward the drywall 14, thereby advancing the gripping elements 12 therein. The T-square 10 may be pushed until the rear face 24 of the head member 18 is disposed adjacent the drywall 14.

As shown in FIG. 2, the gripping elements 12 may be configured to extend only partially through the drywall 14. Along these lines, the drywall 14 defines a first face 30 and a second face 32 to define a drywall thickness “T therebetween. Common drywall thicknesses T used in the construction industry include ¼ inch, ½ inch, or ⅝ inch. The gripping element 12 defines a gripping depth “D” as the distance between the distal tip and the rear face 24 of the head member 18. The gripping depth D is preferably, but not necessarily, less than the drywall thickness T to ensure that the gripping element 12 does not extend completely through the drywall 14. However, the gripping elements 12 also define a gripping depth D that is large enough to support the weight of the T-square 10 when the T-square 10 is connected to or hung from the drywall 14. The T-square 10 may also be fabricated from a lightweight material, such as aluminum or plastic, to reduce the load supported by the gripping elements 12.

Those skilled in the art will appreciate that the gripping elements 12 shown in the Figures are exemplary in nature only and are not intended to limit the scope of the present invention. Along these lines, the depicted T-square 10 includes eight gripping elements 12, although other embodiments may include fewer than eight gripping elements 12 (i.e., one embodiment may include only one gripping element 12), or more than eight gripping elements 12. Furthermore, the gripping elements 12 may define non-triangular shapes known by those skilled in the art. The gripping elements 12 may also be connected to the head member 12 in a random fashion (i.e., not aligned in an array). Gripping elements 12 may also be connected to the tongue member 20 without departing from the spirit and scope of the present invention.

In addition to the foregoing, it is also contemplated that various embodiments of the T-square 10 may include a gripping element 12 that is comprised of an adhesive disposed on the rear surface of the head member 18 to temporarily hold the T-square 10 against the drywall 14. In such adhesive embodiments, the gripping element 12 may not be advanced into the drywall 14 and may instead only engage with an outer surface thereof, so as not to puncture the drywall 14.

The safety of the T-square 10 is additionally enhanced by the inclusion of a cutting channel 16 formed within the tongue member 20. The cutting channel 16 extends through the tongue member 20 from the first face 26 to the second face 28. The cutting channel 16 is sized to allow the blade of the utility knife to extend therethrough to cut or score the drywall 14. In this regard, the cutting channel 16 guides and confines the blade of the utility knife to create a generally linear cut or score along the drywall 14.

As shown, the cutting channel 16 extends generally parallel to the second axis 17 between a first lateral edge 34 of the tongue member 20 and a second lateral edge 36 of the tongue member 20. The cutting channel 16 extends along the tongue member 20 to define a length along the second axis 17. As shown in FIG. 4, the length of the cutting channel 16 is approximately 46.5 inches, although the length of the cutting channel 16 may be varied as desired.

The combination of the gripping elements 12 and the cutting channel 16 significantly simplifies the process of cutting drywall 14. The gripping elements 12 allow the T-square 10 to be temporarily maintained on the drywall 14 while the drywall 14 is being cut. Therefore, after the user has positioned the T-square 10 on the drywall 14, the user is not required to hold the T-square 10 in place. Furthermore, the cutting channel 16 guides the utility knife blade to mitigate drifting of the blade away from the T-square (i.e., the blade is confined within the cutting channel 16 to provide a substantially linear cut/score). The use of the T-square 10 allows the user's efforts to be directed toward creating a safe and precise cut or score along the drywall 14. Along these lines, the user does not have to expend efforts to hold the T-square 10 in place while cutting the drywall 14. Furthermore, the cutting channel 16 guides the utility blade to facilitate the creation of an axial cut or score along the drywall 14.

Although the exemplary embodiment described above and shown in the Figures includes both the gripping elements 12 and the cutting channel 16, it is understood that other embodiments may include one or the other. More specifically, one embodiment may include a T-square 10 that includes the gripping elements 12, but not the cutting channel 16, while other embodiments of the T-square 10 may include the cutting channel 16, but not the gripping element 12.

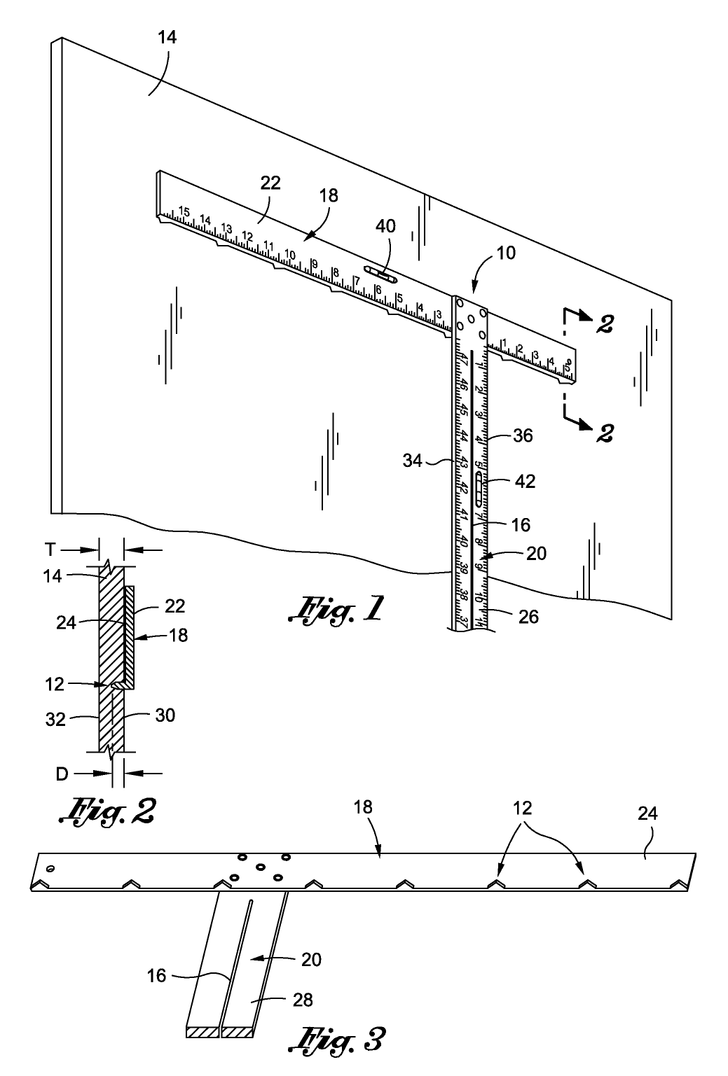

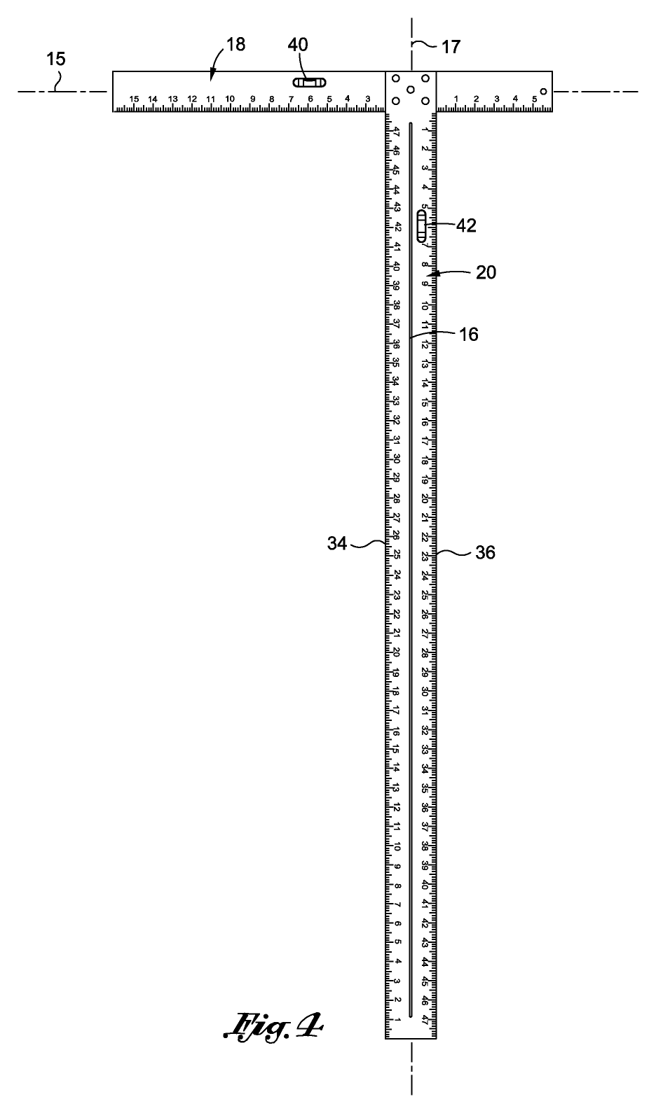

In addition to the gripping elements 12 and the cutting channel 16, the T-square 10 may include additional features which further facilitates drywall cutting. The T-square 10 may include dimensional indicators (i.e., distance lines) displayed on the head member 18 and the tongue member 20 to allow the user to use the T-square 10 for measuring the drywall 14. As shown in FIGS. 1 and 4, the head member 18 includes distance lines which increase in opposite directions from the tongue member 20. The head member 18 extends approximately 16 inches from the tongue member 20 in a first direction and approximately 6 inches from the tongue member 20 in a second direction. The tongue member 20 also includes distance lines displayed adjacent each lateral edge 34, 36. The distance lines are listed from 0-48 inches along the lateral edge 36 and 48-0 along lateral edge 34 in a direction extending away from the head member 18. The distances described above and shown in the drawings are exemplary only and may be varied without departing from the spirit and scope of the present invention.

The T-square 10 may also include on or more levels 40, 42 to facilitate alignment with a vertical or horizontal axis. The depicted embodiment includes a first level 40 connected to the head member 18 and a second level 42 connected to the tongue member 20. As shown the first level 40 may be used to align the T-square 10 with a generally horizontal axis, while the second level 42 facilitates alignment of the T-square 10 along a generally vertical axis.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combinations described herein. Thus, the scope of the claims is not to be limited by the illustrated embodiments.

What is claimed is:

1. A t-square for use with drywall, the t-square comprising:
a t-square body including:
an elongate first member extending longitudinally along a first axis; and
an elongate second member extending longitudinally along a second axis generally perpendicular to the first axis;
the t-square body including a cutting channel formed therein, the cutting channel extending generally along one of the first axis and the second axis; and
a plurality of gripping elements connected to the t-square body, the gripping elements configured to be engageable with the drywall to connect the t-square to the drywall.

2. The t-square recited in claim 1, wherein the plurality of gripping elements are aligned in an array in spaced relation to each other.

3. The t-square recited in claim 1, wherein each gripping element extends from the t-square body and terminates to define a distal apex.

4. The t-square recited in claim 1, wherein the plurality of gripping elements are connected to the elongate first member.

5. The t-square recited in claim 1, wherein the plurality of gripping elements are integrally formed with the elongate first member.

6. The t-square recited in claim 5, wherein the cutting channel is formed within the elongate second member and extends along the second axis.

7. The t-square recited in claim 6, wherein the elongate second member defines a first lateral edge and a second lateral edge, the cutting channel being disposed between the first lateral edge and the second lateral edge.

8. The t-square recited in claim 1, wherein the drywall defines a first surface and an opposing second surface to define a drywall thickness therebetween, each gripping element extending from the t-square body to define a gripping depth, the gripping depth being less than the drywall thickness.

9. The t-square recited in claim 1, further comprising a first level connected to the t-square body.

10. A t-square for use with drywall, the t-square comprising:
a t-square body including:
an elongate first member extending longitudinally along a first axis; and
an elongate second member extending longitudinally along a second axis generally perpendicular to the first axis; and
a gripping element connected to the t-square body, the gripping element configured to be engageable with the drywall to connect the t-square to the drywall.

11. The t-square recited in claim 10, wherein the gripping element includes a plurality of gripping elements connected to the t-square body.

12. The t-square recited in claim 11, wherein the gripping element are aligned in an array in spaced relation to each other.

13. The t-square recited in claim 10, wherein the gripping element extends from the t-square body and terminates to define a distal apex.

14. The t-square recited in claim 10, wherein the gripping element is connected to the elongate first member.

15. The t-square recited in claim 10, wherein the gripping element is integrally formed with the elongate first member.

16. The t-square recited in claim 10, wherein the drywall defines a first surface and an opposing second surface to define a drywall thickness therebetween, the gripping element extending from the t-square body to define a gripping depth, the gripping depth being less than the drywall thickness.

17. The t-square recited in claim 10, further comprising a first level connected to the t-square body.

18. A t-square for use with drywall, the t-square comprising:
an elongate first member extending longitudinally along a first axis to define a first length; and
an elongate second member extending longitudinally along a second axis generally perpendicular to the first axis to define a second length longer than the first length;
the t-square having a cutting channel formed therein, the cutting channel extending generally along one of the first axis and the second axis.

19. The t-square recited in claim 18, wherein the cutting channel is formed completely within the elongate second member.

20. The t-square recited in claim 18, wherein the elongate second member defines a first lateral edge and a second lateral edge, the cutting channel being disposed within the elongate second member between the first lateral edge and the second lateral edge.
